(19) United States
(12) Patent Application Publication
(10) Pub. No.: US 2013/0250755 A1
(43) Pub. Date: Sep. 26, 2013

(54) Real-Time Dynamic Failover For Redundant Data Communication Network

(71) Applicants: Aaron D. Clark, Gilbert, AZ (US); Andrew D. Ellifson, Gilbert, AZ (US)

(72) Inventors: Aaron D. Clark, Gilbert, AZ (US); Andrew D. Ellifson, Gilbert, AZ (US)

(73) Assignee: TruCom, LLC, Gilbert, AZ (US)

(21) Appl. No.: 13/764,143

(22) Filed: Feb. 11, 2013

Related U.S. Application Data
(60) Provisional application No. 61/597,152, filed on Feb. 9, 2012.

(51) Int. Cl. H04L 29/14

(52) U.S. Cl. CPC H04L 69/40
USPC 370/228

(57) ABSTRACT

Systems, methods and computer program products for facilitating real-time, dynamic failover in a redundant data communication network are disclosed. In an aspect of the present disclosure, a service provider offers and monitors a single redundant data communication network that enables a business to have a large number of the business' personnel simultaneously receive primary and secondary data communication services from primary and secondary service providers, respectively. Such a single, redundant data communication network maintains one internet protocol (IP) address, which preserves—and does not drop—the business' in-progress operations during a failover. Additionally, the single data communications network synchronizes data communication services from a variety of data communication service providers thereby ensuring the business can perform all operations when switching from the primary service provider to the secondary service provider during real-time, dynamic failover.

### CROSS-REFERENCE TO RELATED APPLICATION

This Application claims priority to co-pending, U.S. Provisional Patent Application No. 61/597,152 (Attorney Docket No. 2223.01), titled “Real-Time Dynamic Failover In Redundant Data Communication Network,” filed on Feb. 9, 2011, which is hereby incorporated by reference as to its entire contents.

### BACKGROUND OF THE DISCLOSURE

1. Field of the Disclosure

The present disclosure generally relates to data communications, and more particularly to systems, methods, and computer program products for facilitating real-time, dynamic failover in a redundant data communication network.

2. Related Art

In today's technological environment, convergence of data communication services is a necessity for businesses. That is, businesses with sophisticated operations (e.g., call centers, POS/retail sites, restaurants, hotels, sports venues, etc.) require a variety of data communication services (e.g., voice, video, facsimile, cable, DSL, VoIP, GPS, SMS, etc.). Such data communication services can be simultaneously transmitted via wired and wireless communication networks (i.e., redundant data communication network) to the business. Currently, a business must purchase a first data communication service (i.e., wireline or primary service) from one service provider (i.e., primary service provider) and a second, backup data communication service (i.e., wireless or secondary service) from another service provider (i.e., secondary service provider).

The secondary service provider must be capable of providing wireless (i.e., microwave point-to-point) data communication services that typically require dedicated equipment. Such wireless data communication services operate on a network that is different from the primary service provider's network. That is, each service provider requires the business to employ separate data communication equipment (e.g., wireline modem, wireless modem, router, network switch, etc.). As a result, businesses must hire both primary and secondary service providers—usually separate wireline and wireless service providers—and pay a higher price for each data communication service because neither service provides all requisite data communication services.

During a service outage from the primary service provider, the business loses the ability to conduct its daily operations (e.g., send/receive telephone calls, process real-time customer data, post credit card transactions, etc.). The business must then manually redirect its network interface between the primary and secondary service providers (e.g., toggle data communications services). That is, data communication services must be physically switched from the primary data communication equipment to the secondary data communication equipment (i.e., toggling network switches, resetting modems and routers, disconnecting cables, etc.). Such a task is cumbersome and time consuming, especially when the primary and secondary data communication equipment are located at remote sites or require additional interface devices. In addition, the business must redirect their software systems to the secondary service provider's network by manually changing firewall settings, gateway protocols, IP addresses, etc.

When the secondary service provider is not designed to facilitate the business' sophisticated operations such as Multiprotocol Label Switching (MPLS), such manual switching is merely a temporary solution—typically a day or less—until the primary service provider restores the primary data communications service to the business' network. Furthermore, if both primary and secondary data communication services are not monitored by a single system, the business will not know whether the secondary data communication service is even available as a backup to the primary communication service. That is, the business must initially complete the manual switching process (i.e., switch between primary to secondary data communications service providers) to learn whether the secondary data communication service is properly functioning. If the secondary data communication service is not properly functioning, the business must manually revert back to the primary data communication service. Such manual and reverse switching processes are inefficient and costly for the business.

One automated process for switching between primary and secondary service providers in a data communication network is known as “failover.” Failover instantly transfers tasks from failed data communication equipment to similar redundant data communication equipment for maintaining operations and avoiding disruption. That is, failover will occur when the operation of the failed primary data communication equipment (e.g., controller, disk drive, server, etc.) is transferred to a redundant secondary data communication equipment to ensure there is no gap in data flow and operation. If the primary data communication equipment is the subject of either failure or scheduled down time, the secondary data communication equipment serves as a backup and takes over for its failed counterpart.

When primary and secondary data communications services (e.g., equipment) permanently run in parallel, data from both service providers remain synchronized at all times. Although such synchronized data communication services are more reliable than unsynchronized services, the business still remains clueless regarding the functioning status of the secondary service provider. Currently, customers do not have the ability to monitor such anticipated transitions (e.g., whether secondary service provider is available when the primary service provider is non-functioning).

Given the foregoing, what is needed are systems, methods and computer program products for facilitating real-time, dynamic failover in a redundant data communication network.

### BRIEF DESCRIPTION OF THE DISCLOSURE

This summary is provided to introduce a selection of concepts in a simplified form that are further described below in the Detailed Description. This summary is not intended to identify key features or essential features of the disclosure, nor is it intended to be used to limit the scope of the disclosure.

The present disclosure addresses the above-identified needs by systems, methods and computer program products for facilitating real-time, dynamic failover in a redundant data communication network.

In an aspect of the present disclosure, a service provider offers and monitors a single redundant data communication network (i.e., combination of wireless and wireline networks) that enables a business (e.g., a university, a company/business enterprise or local, state or federal government department or agency, a charitable entity or any other type of organization or entity) to have a large number of the business' personnel (e.g., call center operators, telemarketers, fundraisers, customer service representatives, etc.) simultaneously receive primary and secondary data communication services from primary and secondary service providers, respectively. Such a single, redundant data communication network maintains one internet protocol (IP) address, which preserves—and does not drop—the business' in-progress operations (e.g., phone calls, credit card transactions, cloud computing, Internet surfing, etc.) during a failover (e.g., interruption of primary or secondary services).

In one aspect of the present disclosure, the single, redundant data communication network employs a single data communication equipment (e.g., Juniper J Series router, available from Juniper Network, Inc. of Sunnyvale, Calif., with a dynamic routing protocol) residing at the business' site. Such a single data communication equipment is communicative coupled a fiber optic network (i.e., redundant SONET fiber optic network) capable of simultaneously receiving and synchronizing both wireline and wireless data communication services. In such an aspect, the business is able to achieve real-time, dynamic failover between primary and secondary services without down time and without having to constantly redirect wireless and wireline equipment during failover.

In another aspect of the disclosure, the service provider continuously monitors the status of the single, redundant data communication network. In such an aspect, the availability of both primary and secondary service providers is verified thereby providing reliable real-time, dynamic failover.

In yet another aspect, the single, redundant data communications network synchronizes data communication services (e.g., wireless and wireline services) from a variety of data communication service providers thereby ensuring the business can perform all operations when switching from the primary service provider to the secondary service provider during real-time, dynamic failover.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system for facilitating real-time, dynamic failover in a redundant data communication network according to an embodiment of the present disclosure.

FIG. 2 is a diagram illustrating a single, redundant data communication network to fiber optic backbone and data centers, according to an embodiment of the present disclosure.

FIG. 3 is a flowchart illustrating operation of the system shown in FIG. 1, according to an embodiment of the present disclosure.

FIG. 4 is a flowchart illustrating data flow when a wireline service provider is active, according to an embodiment of the present disclosure.

FIG. 5 is a flowchart illustrating data flow when a wireless service provider is active, according to an embodiment of the present disclosure.

FIG. 6 is a block diagram of an exemplary computer system useful for implementing the present disclosure.

### DETAILED DESCRIPTION

In the drawings, like numerals indicate like elements throughout. Certain terminology is used herein for convenience only and is not to be taken as a limitation on the present disclosure. The terminology includes the words specifically mentioned, derivatives thereof and words of similar import. The embodiments illustrated below are not intended to be exhaustive or to limit the disclosure to the precise form disclosed. These embodiments are chosen and described to best explain the principle of the disclosure and its application and practical use and to enable others skilled in the art to best utilize the disclosure.

In an aspect of the present disclosure, a service provider offers real-time, dynamic failover service that enables a business to automatically switch between primary (i.e., wireline) and secondary (i.e., wireless) data communication services via in a redundant data communication network residing at the business' site. Transition between the primary and secondary services enables the business to continue sophisticated operations (e.g., MPLS and QOS) with both the wireline and wireless data communication services in an uninterrupted manner during a failover. Such uninterrupted transitions allow, for example, calls to not be dropped, credit card processing in progress during failover to not be effected, browsing and streaming activity over the internet to not be interrupted, and data not to be lost.

In another aspect of the present disclosure, the real-time, dynamic failover service may be utilized by any organization that provides call center support for customer-based businesses, such as software developers, credit card companies, retail centers, automobile dealers, hotels, insurance companies, financial institutions, government agencies and the like. Such organizations would use the real-time, dynamic failover service provided by the present disclosure to send/receive customer data as well as preserve customer data transmitted over the primary and second service networks.

The present disclosure is now described in more detail herein in terms of the above exemplary business services context. This is for convenience only and is not intended to limit the application of the present invention. In fact, after reading the following description, it will be apparent to those skilled in the relevant art(s) how to implement the following disclosure in alternative aspects.

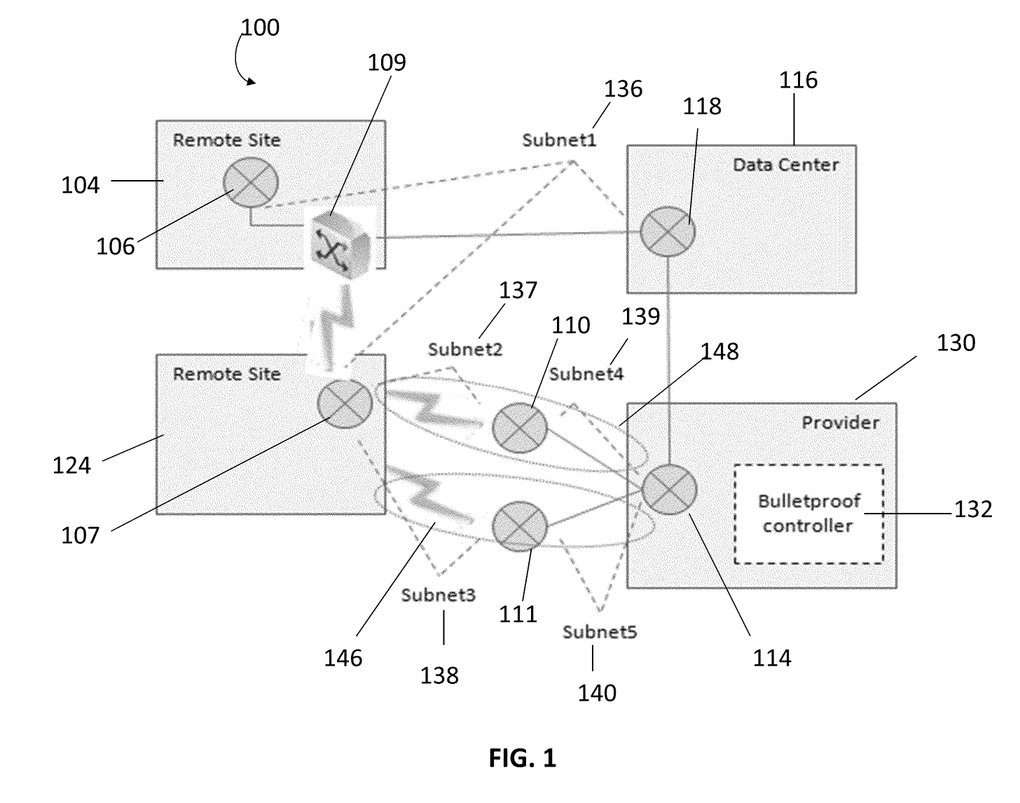

Referring to FIG. 1, a block diagram of an exemplary environment for facilitating real-time, dynamic failover in a redundant data communication network, according to an embodiment of the present disclosure, is shown. More specifically, a fiber optic-based, real-time dynamic backhaul telecommunications infrastructure 100 includes a plurality of remote sites 104, 124 comprised of multiple user applications (i.e., hardware and/or software components all communicatively coupled), a plurality of data centers 116, remotely located routers 106-111 between the backbone of the network and the small sub-networks 136-140 comprised of at least a pair of preconfigured ports (e.g., wireline port with a high cost route and a wireless port with a low cost route) for facilitating wireline and wireless communications throughout the telecommunication infrastructure 100.

As shown in FIG. 1, in an aspect of the present disclosure, an application service provider's network-based, dynamic failover infrastructure 100 may further include a service provider 130, a network controller 132, redundant wireline and wireless service delivery methods 146, 148, at least one asynchronous time-division multiplexer 109, a plurality of wireless microwave radio relays, and a plurality of fiber optic communication devices.

In the present embodiment, infrastructure 100 provides a plurality of redundant connections 146, 148 corroborated with an end-to-end computer networking system (i.e., the application-specific functions reside in the end host of a network rather than in intermediary nodes, provided they can be implemented completely and correctly in the end hosts). Thus, by interconnecting its entire network of fiber optic rings (e.g., SONET/ADH) end-to-end, the quality of the network improves and will never experience a business blackout (i.e., no dropped telephone calls, no data lost, credit card transactions will process, no lost internet connections, etc.).

In an aspect of the present disclosure, as shown in FIG. 1, a backhaul telecommunication infrastructure 100 may include a network controller 132 to facilitate communication amongst a network and ensure a balanced equilibrium. The network controller 132 acts as a telecommunication path selector and forwarder for transmitted or received packets based on the signal strength and status of the configured network. For example, the network controller 132 will continuously oversee and record the signal strength and status of the active and standby configurations by intercepting data acquired from a proprietary software protocol, located in the data center 116, which measures the quality of incoming signals to each remote site 104 & 124 via sub-network 136, and if the network controller 132 detects a failure of the active communication path the controller 132 will activate the standby connection and convert the active path to standby via asynchronous time-division multiplexer 109 (e.g., ATM switch) and then dissociate any user nodes from the down communication path to the active communication path. The network controller 132 will reconfigure the standby communication path and any dissociated user nodes.

As will be appreciated by those skilled in the relevant art(s) after reading the description herein, an embodiment comprised of the features presented in FIG. 1 will continuously communicate data over the network between remote sites 104, 124, data centers 116, provider 130, and network controller 132. Network controller 132 will monitor the connectivity status of wireline and wireless connections via data center 116 and will conduct a system failover if the signal strength of the active communication device is lost or falls below the preconfigured router settings.

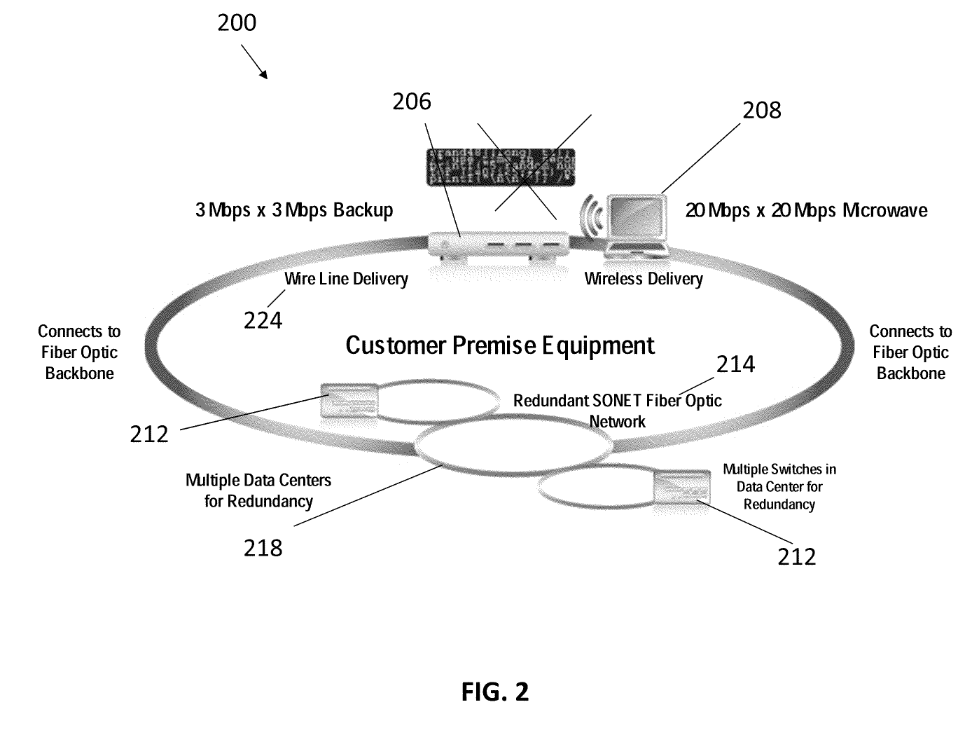

Referring to FIG. 2, a diagram illustrating a single, redundant data communication network 200 to fiber optic backbone and data centers, according to an embodiment of the present disclosure, is shown. As shown in FIG. 1, in an aspect of the present disclosure, an application service provider's real-time, dynamic failover infrastructure 100 may include a network controller 132 to facilitate communication amongst a network and ensure a balanced equilibrium. Network controller 132 acts as a telecommunication path selector and forwarder for transmitted or received packets based on the signal strength and status of the configured network. For example, network controller 132 will continuously oversee and record the signal strength and status of the active and standby configurations by intercepting data acquired from a proprietary software protocol, located in data center 116, which measures the quality of incoming signals to each remote site 104, 124 via sub-network 136. If network controller 132 detects a failure of the active communication path, controller 132 will activate the standby connection and convert the active path to standby via asynchronous time-division multiplexer 109 (e.g., ATM switch). Then, controller 132 will dissociate any user nodes from the down communication path to the active communication path, and will reconfigure the standby communication path and any dissociated user nodes.

As shown in FIG. 2, router 206 includes a plurality of preconfigured delivery ports (e.g., wireline delivery port 224 and wireless delivery port 208). Each router 206 is preconfigured by a provider (e.g., business personnel) to automatically failover to the backup delivery method in the event the active delivery method connection status (i.e., bandwidth or speed of your internet connection) falls below the preconfigured settings. Redundant fiber optic network 214 (e.g., SONET) is comprised of multiple switches 212 (e.g., ATM switch) which collectively work to ensure redundancy and stability within a single network. As referred to in FIG. 1, in event of a dynamic failover, controller 132 will activate the standby delivery method (e.g., wireless microwave 208 in the event the wireline delivery 224 was active) via multiple switches in the data centers for redundancy 212. Redundant wireline 224 and wireless 208 services, in connection with redundant SONET fiber optic network 214, facilitate a continuous working environment.

As will be appreciated by those skilled in the relevant art(s) after reading the description herein, an embodiment comprised of the features presented in FIG. 2 has the ability to work in unison with a redundant SONET fiber optic network to facilitate a failover provided by redundant wireline and wireless service delivery methods.

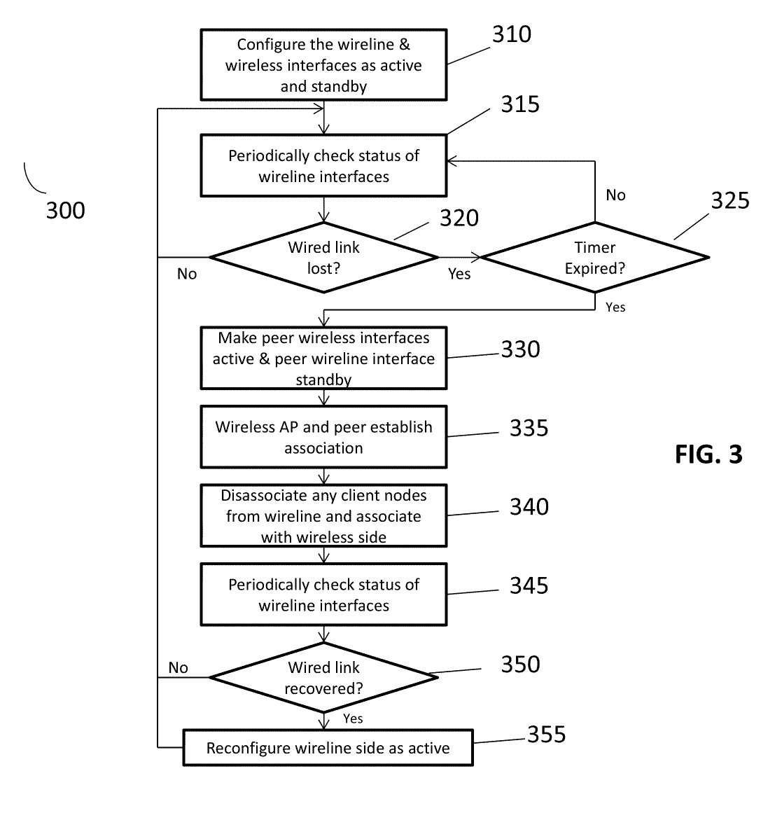

Referring now to FIG. 3, a flowchart illustrating the function of the system shown in FIG. 1, according to an embodiment of the present disclosure, is shown. That is, a failover process 300 is shown in FIG. 3, where at startup, in step 310, both wireline and wireless interfaces boot up with active and standby modes pre-configured, respectively. Next, in step 315, controller 132 periodically checks the status of the wireline interface. Next, in step 320, controller 132 determines whether the wired link has been lost. If the determination of step 320 is negative, controller 132 will revert back to step 315 and periodically check the status of the wireline interface. On the other hand, if the determination of step 320 is affirmative, process 300 proceeds to step 325.

In step 325 it is determined if a timer has expired. If yes, process 300 proceeds to step 330, otherwise process 300 returns to step 315. In step 330, controller 132 will activate peer wireless interfaces and place the peer wireline interface in standby. Next, in step 335, wireless Access Point (AP) and peer establish connectivity. Next, in step 340, controller 132 disassociates client nodes from wireline to wireless mode. Next, in step 345, controller 132 periodically checks the status of the wireline interface. Next, in step 350, controller 132 determines whether the wireline connection has recovered. If no, controller 132 will continue to periodically check the status of the wireline interfaces. If yes, controller 132 will reconfigure the wireline status from standby to active in step 355. After step 355, controller 132 will continue to monitor the status of the wireline interface in order to ensure proper connection.

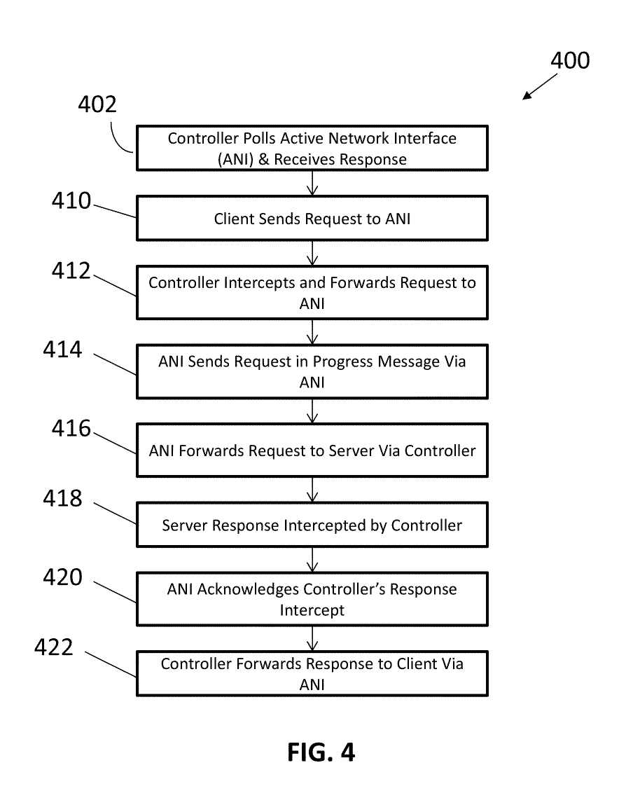

Referring to FIG. 4, a flowchart illustrating a data flow 400 when a wireline service provider is active, according to an embodiment of the present disclosure, is shown. Initially, in step 402, controller 132 polls the wireline interface and in return receives a poll response. Next, in step 410, a client sends a request to an active network interface (ANI). Next in step 412, the request is intercepted by controller 132 and forwarded to the active wireline interface. Next, in step 414, a “Request_in_Progress” message is then sent to the client via ANI. Next, in step 416, the request is forwarded from the wireline interface via controller 132 to the server. Next, in step 418, the server's response is intercepted by controller 132. Next, in step 420, the ANI acknowledges the response to the intercepted message received from controller 132. Finally, in step 422, controller 132 forwards the response to the client via ANI.

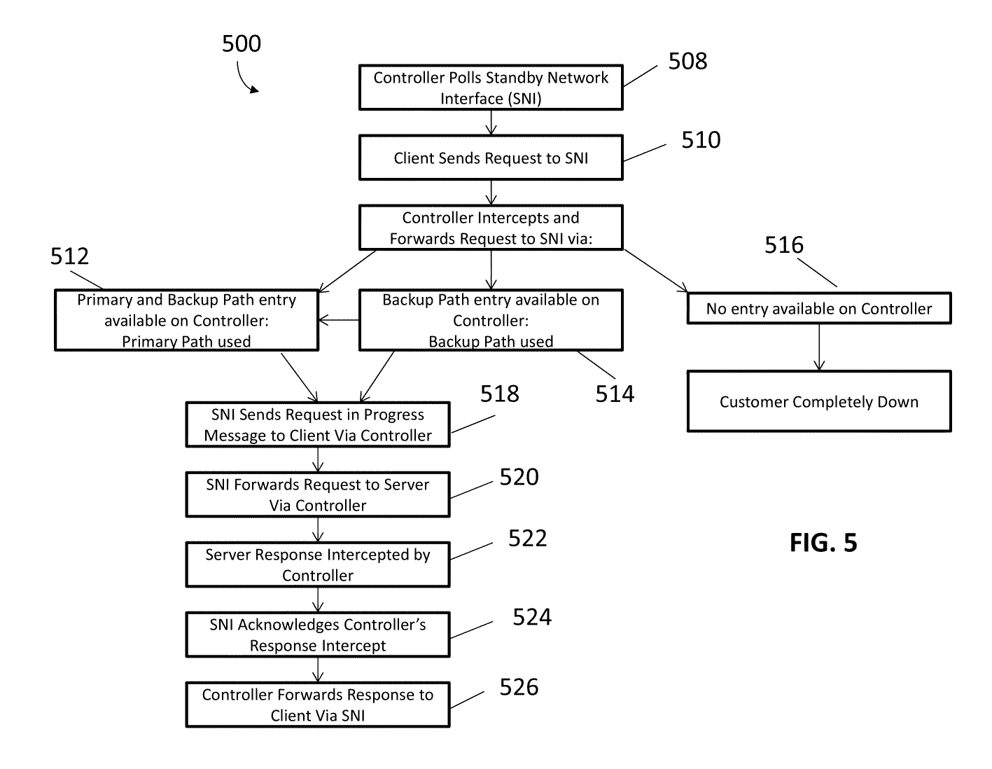

Referring to FIG. 5, a flowchart illustrating data flow 500 when a wireless service provider is active, according to an embodiment of the present disclosure, is shown. Initially, in step 508, controller 132 polls the wireless interface and in turn receives a poll response. Next, in step 510, the client sends a request to the standby network interface (SNI). The next step of dataflow 500 depends on the existing entries available on the controller. In step 512, if the controller has an entry existing for the primary and backup paths, controller 132 intercepts and forwards the request via the primary path (wireless link) to the SNI. In step 514, if the wireless link entry on the controller goes down, then that entry is removed and controller 132 intercepts and forwards the request via the backup path (wireline) to the SNI. In step 516, if neither primary nor backup paths are available on controller 132, then the customer is completely down and no information is forwarded to the SNI.

Returning to step 512, where the controller has an entry existing for the primary and backup paths, dataflow 500 proceeds to step 518. In step 518, controller 132 intercepts and forwards the request again using the primary path. Next, in step 520, the SNI sends a “Request_in_Progress” message to the client via controller 132. Next, in step 522, the request is forwarded from the SNI to the server via controller 132. The server's response is then intercepted by controller 132. Next, in step 524, the SNI acknowledges the response to the intercepted message received from controller 132. Finally, in step 526, controller 132 forwards the response from the server to the client.

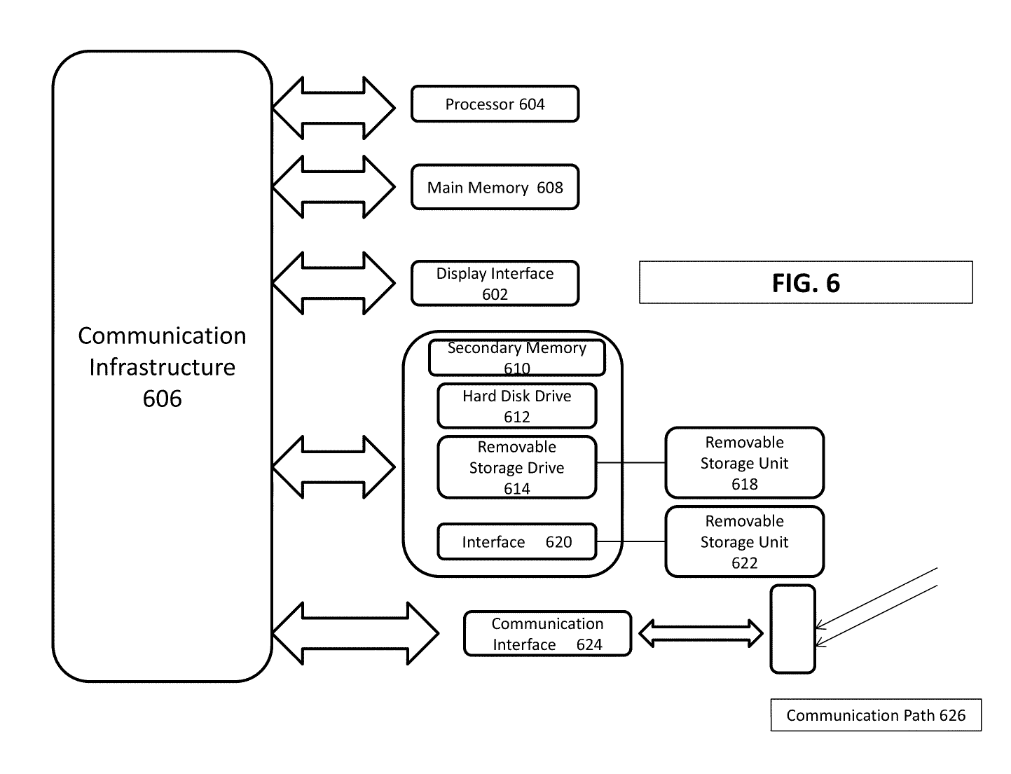

In one aspect, infrastructure 100 may be directed toward one or more computer systems capable of carrying out the functionality (e.g., processes 300, 400 and 500) described herein. An example of a computer system 600 is shown in FIG. 6. Computer system 600 includes one or more processors, such as processor 604. Processor 604 may be connected to a communication infrastructure 606, such as a communications bus or network, for example. Various software aspects are described in terms of this exemplary computer system. After reading this description, it will become apparent to a person skilled in the relevant art(s) how to implement the disclosure using other computer systems and/or architectures.

Computer system 600 can include a display interface 602 that forwards graphics, text and other data from communication infrastructure 606, or from a frame buffer (not shown), for display via display unit 630. Computer system 600 may also include a main memory 608, preferably a random access memory (RAM), and may further include a secondary memory 610. Secondary memory 610 may include, for example, a hard disk drive 612 and/or a removable storage drive 614, representing a floppy disk drive, a magnetic tape drive, or an optical disk drive, for example. Removable storage drive 614 reads from and/or writes to a removable storage unit 618 in a manner well known in the relevant art. Removable storage unit 618 represents a floppy disk, magnetic tape, or an optical disk, which is read by and written to by removable storage drive 614. As can be appreciated, removable storage unit 618 includes a computer usable storage medium having stored therein computer software and/or data.

In alternative aspects, secondary memory 610 may include other similar devices for allowing computer programs or other instructions to be loaded into computer system 600. Such devices may include, for example, a removable storage unit 622 and an interface 620. Examples of such may include a program cartridge and cartridge interface, such as may be found in video game devices, a removable memory chip, such as an erasable programmable read only memory (EPROM), or programmable read only memory (PROM), and associated socket and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of a communications interface 624 may include a modem, a network interface such as an Ethernet card, a communications port, and a Personal Computer Memory Card International Association (PCMCIA) slot and card. Software and data transferred via communications interface 624 are in the form of non-transitory signals 628 which may be electronic, electromagnetic, optical or other signals capable of being received by communications interface 624. Signals 628 may be provided to communications interface 624 via a communications path or channel 626. Channel 626 may carry signals 628 and may be implemented using wire or cable, fiber optics, a telephone line, a cellular link, a radio frequency (RF) link, and other communications channels.

In this document, the terms “computer program medium” and “computer usable medium” are used to generally refer to media such as removable storage drive 614, a hard disk installed in hard disk drive 612, and signals 628. These computer program products provide software to computer system 600, wherein the present disclosure is directed to such computer program products.

Computer programs (also referred to as computer control logic), may be stored in main memory 608 and/or secondary memory 610. Computer programs may also be received via communications interface 624. Such computer programs, when executed, enable computer system 600 to perform the features of the present disclosure, as discussed herein. In particular, the computer programs, when executed, enable processor 604 to perform the features of the present disclosure. Accordingly, such computer programs represent controllers of the computer system 600.

In an aspect where the disclosure is implemented using software, the software may be stored in a computer program product and loaded into computer system 600 using removable storage drive 614, hard drive 612 or communications interface 624. The control logic (software), when executed by processor 604, causes processor 604 to perform the functions of the disclosure as described herein.

In another aspect, the disclosure is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown in FIG. 6 may be configured as a desktop, a laptop, a server, a tablet computer, a PDA, a mobile computer, an intelligent communications device or the like. In yet another aspect, the disclosure may be implemented using a combination of both hardware and software.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

1. A system for facilitating real-time, dynamic failover in a redundant data communication network, comprising:
at least one asynchronous time-division multiplexer;
at least one wireline connection;
at least one wireless connection; and
a network controller, capable of polling said wireline connection and said wireless connection in order to synchronize, via said asynchronous time-division multiplexer, data communication services between said wireline connection and said wireless connection;
wherein a single internee protocol (IP) address is associated with the redundant data communication network.

2. The system of claim 1, wherein said at least one wireline connection is preconfigured as an active communication path and said at least one wireless connection is preconfigured as a standby communication path.

3. The system of claim 1, wherein said network controller is configured to:
generate a first recording of a signal strength of said at least one wireline connection; and
generate a second recording of a signal strength of said at least one wireless connection.

4. The system of claim 3, wherein said network controller is further configured to compare said first recording to a wireline minimum signal strength and transfer data over the redundant communication network via said at least one wireless connection if said first recording is below said wireline minimum signal strength.

5. The system of claim 4, wherein said network controller is further configured to compare said second recording to a wireless minimum signal strength and transfer data over the redundant communication network via said at least one wireline connection if said second recording is below said wireless minimum signal strength.

6. The system of claim 1, further comprising:
at least one subnetwork comprising one of: a portion of said at least one wireline connection and a portion of said at least one wireless connection.

7. The system of claim 6, wherein said network controller is further configured to perform said polling via said at least one subnetwork.

8. The system of claim 6, wherein said network controller is further configured to:
generate a first recording of a signal strength of said at least one subnetwork.

9. The system of claim 8, wherein said network controller is further configured to compare said first recording to a subnetwork minimum signal strength and transfer data over the redundant communication network via said at least one wireless connection if said first recording is below said subnetwork minimum signal strength.

10. The system of claim 1, wherein said at least one wireless connection comprises:
at least one wireless microwave radio relays configured to transfer data.

11. The system of claim 1, wherein said at least one wireline connection comprises:
at least one fiber optic communication devices configured to transfer data.

12. A controller device for facilitating real-time, dynamic failover in a redundant data communication network, comprising:
at least one wireline connection point configured to connect to the redundant data communication network;
at least one wireless connection point configured to connect to the redundant data communication network; and
a computing device comprising:
at least one computing device storage media; and
at least one processor;
wherein said computing device is communicatively connected to said at least one wireline connection point and said at least one wireless connection point;
wherein said computing device is configured to monitor said at least one wireline connection point and said at least one wireless connection point in order to synchronize data communication services over the redundant data communication network; and
wherein a single internet protocol (IP) address is associated with the redundant data communication network.

13. The controller device of claim 12, wherein said controller device is located in a data center of the redundant data communication network.

14. The controller device of claim 12, wherein said controller device is configured to:
monitor a plurality of wireline data packets received at said at least one wireline connection point;
monitor a plurality of wireless data packets received at said at least one wireless connection point;
generate a first recording of a signal strength related to said monitoring of said plurality of wireline data packets; and
generate a second recording of a signal strength related to said monitoring of said plurality of wireless data packets.

15. The controller device of claim 14, wherein said controller device is configured to compare said first recording to a wireline minimum signal strength and transfer data over the redundant communication network via said at least one wireless connection point when said first recording is below said wireline minimum signal strength.

16. The controller device of claim 15, wherein said controller device is configured to compare said second recording to a wireless minimum signal strength and configured to transfer data over the redundant communication network via said at least one wireline connection point when said second recording is below said wireless minimum signal strength.

17. A method for facilitating real-time, dynamic failover in a redundant data communication network, comprising:
(a) polling at least one wireline connection and at least one wireless connection via a network controller; and
(b) synchronizing data communication services between said at least one wireline connection and said at least one wireless connection via an asynchronous time-division multiplexer;
(c) generating a first recording of a signal strength of said at least one wireline connection;
(d) generating a second recording of a signal strength of said at least one wireless connection; and
(e) determining if said first recording is greater than a wireline minimum signal strength; and
(f) transferring, when step (e) is positive, data over the redundant communication network via said at least one wireless connection;
wherein a single Internet protocol (IP) address is associated with the redundant data communication network.

18. The method of claim 17, further comprising:
(g) determining if said second recording is greater than a wireless minimum signal strength; and
(h) transferring, when determining step (g) is positive, data over the redundant communication network via said at least one wireline connection.

19. A computer readable storage medium for storing computer readable instructions, the computer readable instructions facilitating the operation of a real-time, dynamic failover in a redundant data communication network the computer readable instructions comprising;
(a) logic configured to poll at least one wireline connection and at least one wireless connection via a network controller;
(b) logic configured to synchronize data communication services between said at least one wireline connection and said at least one wireless connection via an asynchronous time-division multiplexer;
(c) logic configured to generate a first recording of a signal strength of said at least one wireline connection;
(d) logic configured to generate a second recording of a signal strength of said at least one wireless connection
(e) logic configured to determine if said first recording is greater than a wireline minimum signal strength; and
(f) logic configured to transfer, when said first recording is greater than said wireline minimum signal strength, data over the redundant communication network via said at least one wireless connection
wherein a single internet protocol (IP) address is associated with the redundant data communication network.

20. The computer readable storage medium of claim 19, further comprising:
(g) logic configured to determine if said second recording is greater than a wireless minimum signal strength; and
(h) logic configured to transfer, when said second recording is greater than said wireless minimum signal strength data over the redundant communication network via said at least one wireline connection.
